(19) United States
(12) Patent Application Publication
(10) Pub. No.: US 2012/0136289 A1
(43) Pub. Date: May 31, 2012

(54) Inductive charging personal massager

(76) Inventor: Ryan McGann, Shoreham, NY (US)

(21) Appl. No.: 13/290,523

(22) Filed: Nov. 7, 2011

Related U.S. Application Data
(60) Provisional application No. 61/456,489, filed on Nov. 5, 2010.

(51) Int. Cl. A61H 1/00

(52) U.S. Cl. 601/78

(57) ABSTRACT

An inductive charging personal massager, in general, is provided that is capable of recharging its internal energy storage system both during operation, and when in a standby mode. One method of recharging will be through electromagnetic induction, and may include a coil of conductive material and a magnet with magnetic properties. The inductive charging personal massager preferably uses at least one of each of the following systems to effectively perform its designed task; a vibration system, an internal energy storage system, an internal electromagnetic induction charging system consisting of a coil and magnet, a charge protection system, a charge controlling system/charge rectifying system, and an external coil attachment for use with the internal induction charging system.

This application claims priority on U.S. Application Ser. No. 61/456,489 filed Nov. 5, 2010 the disclosures of which are incorporated herein by reference.

### FIELD OF THE INVENTION

This invention relates generally to the personal massaging industry, and improvements in technology concerning the personal message devices containing a vibrating means such as vibrating motor(s). This invention also relates to methods of recharging the energy storage systems of a personal massager, particularly with the use of a electromagnetic induction charging systems.

### BACKGROUND OF THE INVENTION

Over the years, the vibrating personal massager have been seen in a variety of configurations, and performed a variety of functions—from medical therapy to erotic stimulation. All of which containing some sort of power system, whether being disposable batteries or conventional AC electricity that plugs into a home wall outlet.

The conventional powering systems of today's personal massagers can be cumbersome and inconvenient. They also tend to be hazardous to the environment. Disposal of batteries have proven extremely hazardous to the environment, and powering the personal massager through the mass power grid of a home wall outlet adds to the emission of CO2 and other greenhouse gasses that may contribute to global warming and other harmful effects to the environment. The present invention incorporates an environmentally friendly recharging system that converts the mechanical energy of the user into electrical energy for recharging its internal energy storage system, making the inductive charging personal massager a more efficient and eco-friendly product for the industry. Personal vibrating massagers' containing disposable batteries operate for a period of time until the charge is drained. Once the charge is drained, the user is required to disassemble the device, and replace the discharged batteries—often throwing them into the garbage that ends up in landfills without proper recycling practices. Not only is the disassembly and disposal of the batteries environmentally hazardous, it is also inconvenient and expensive for the user. Even if rechargeable batteries are used the device still has to be disassembled and the batteries placed in a charger where they can be recharged for further use.

Personal vibrating massagers' operating on AC power, either 110v or 220v also have their downfalls. Personal massagers that are powered by an AC wall outlet are restricted to a set distance from the wall outlet, and must have a functioning wall outlet within the proximity of intended use or an extension cord. Without an available power grid, the vibrating function will not be powered. Personal massagers that are powered by AC power also tend to be unsafe when using in damp locations.

In the paragraphs discussed above, there are multiple reasons why replacement batteries and direct AC powered devices are inconvenient, costly, and potentially harmful in damp conditions. It will be apparent to the reader that there is a need for improvement with the energy storage system, and methods of recharging the said energy storage system of a vibrating personal massager. The inductive charging personal massager of the present invention uses electromagnetic induction systems to recharge its internal energy storage system that runs the vibration system. Electromagnetic induction was first discovered by Michael Faraday in 1831. He discovered that a varying electromagnetic or magnetic field near a coil of conductive material will produce an electric current.

### SUMMARY OF THE INVENTION

The inductive charging personal massager, in general, is a vibrating massager that is capable of recharging its internal energy storage system both during operation, and when in a standby mode. One method of recharging will be through electromagnetic induction, and may include a coil of conductive material and a magnet with magnetic properties. The inductive charging personal massager preferably uses at least one of each of the following systems to effectively perform its designed task; a vibration system, an internal energy storage system, an internal electromagnetic induction charging system consisting of a coil and magnet, a charge protection system, a charge controlling system/charge rectifying system, and an external coil attachment for use with the internal induction charging system.

### OBJECTS OF THE INVENTION

It is an object of the invention to provide a personal massager that includes at least one device for generating a vibrating motion. This device may generate a vibration by, but not limited to; an electric motor of either alternating current or direct current with an offset weight mounted to the driveshaft, a piezoelectric material, coil of for example, copper or other suitable conductive material, solenoid, an electromagnetic relay, and/or any combination of the above methods.

It is an object of the invention to provide a personal massager with an internal electromagnetic induction system including a coil of conductive material, a magnet with magnetic properties, and a magnet shaft where the magnet is able to oscillate back and forth through the shaft. The coil is preferably mounted in a central location on the outside of and around the magnet shaft. When the magnet passes through the coil, a current is induced within the coil.

It is an object of the invention to provide a personal massager with a means for storing energy. This internal energy storage system is used to store energy and power the electronic components of the device. This power storage device may be, but is not limited to; a battery of any functional chemistry composition, power capacitor, compressed air that powers a generator, hydrogen separation and fuel cell system, a capacitor, mechanical energy storage such as a flywheel, and/or any combination of the above mentioned methods.

It is an object of the invention to provide a personal massager with a method of recharging its internal power storage system. This method of recharging the internal power storage system may include, but is not limited to; a electromagnetic charging system, a photovoltaic solar cell, fuel cell, pneumatic generator, thermoelectric generator, and/or any combination of the above mentioned methods.

It is an object of the invention to provide a personal massager with a charge control device for rectifying alternating current, or AC, produced from the electromagnetic induction to direct current, or DC, for proper energy storage and function of the on board electronics. This charge control device also stops the current from flowing from the energy storage device to the internal coil.

It is an object of the invention to provide a personal massager where the vibration device can be telescopically extended away from the handle, increasing the reach of the device, and compact storage.

It is an object of the invention to provide a personal massager that can be wirelessly recharged through induction. An outer coil ring that is powered by an alternating current from home wall outlet, may be placed concentrically around a coil inside of the personal massager that is connected to the internal power storage system. The external charge ring produces a varying magnetic field around the internal coil, inducing an alternating current within the internal coil.

It is an object of the invention to provide a personal massager with a system of protecting the internal energy storage system from charging beyond its means may be used to protect the system from damage and/or failure. There are many ways to monitor and control the charging of the internal energy storage system. These methods of safely charging and monitoring charge levels in the internal energy storage system may include, but are not limited to; digitally monitoring charge level and charge input, timer controlled, thermal cutoff to stop charge when the internal storage system temperature increases above a specific temperature—usually indicating a full charge, slow charging at a small fraction of the total capacity of the energy storage system at a slower rate—also known as trickle charging, and/or fast charging at a higher percentage of total charge capacity of the energy storage system with active level monitoring. Any of the above systems may be used independently of each other, or any combination with any number of the said charge controlling methods.

It is an object of the invention to provide a personal massager with a rebounding system to rebound the induction magnet back and forth though the magnet shaft. This rebounding device may use metal springs, elastomeric springs, and/or magnets to rebound the induction magnet. Smaller magnets for rebounding the induction magnet, may be placed inside of the bumpers. This rebound device also dampens the induction magnets impact for quieter operation.

It is an object of the invention to provide a personal massager with different sized and shaped end caps where the massaging motion is intended to be translated through.

It is an object of the invention to provide a personal massager with an outer casing that encloses the inner mechanisms. This outer casing may be made of, but not limited to, the following materials; metal, plastic polymer, silicone, rubber, and/or any combination of these materials. The outer casing may also be fluid/water tight. Epoxy sealant and O-Rings may be used to properly seal off the inner mechanisms and systems form water and/or fluid damage.

It is an object of the invention to provide a personal massager with a method of controlling the intensity of vibration. One method of controlling the intensity of vibration is to vary the resistance between the internal energy storage system, and the vibration system. A variable resistor or potentiometer can be used to vary the voltage flowing from the internal energy storage system to the vibration system. If the vibration system is a rotary DC electric motor with an offset weight, the potentiometer will vary the RPM's (rotations per minute) of the motors shaft, respectively varying the intensity of vibration.

### BRIEF DESCRIPTION OF THE FIGURES

FIG. 1a and FIG. 1b are views of the whole induction charging personal massager assembly.

FIG. 2a and FIG. 2b are side cut views of the whole induction charging personal massager assembly.

FIG. 3 is another side cut view of the whole induction charging personal massager assembly.

FIG. 4a and FIG. 4b are cut away views of the induction charging personal massager assembly that shows the internal magnet sliding back and forth through the internal coil.

FIG. 5a and FIG. 5b are exploded views of all the components of the induction charging personal massager assembly.

FIG. 6 is a view of the induction charging personal massager with the top half of the components removed.

FIGS. 7a, 7b, and 7c illustrate the O-Ring and Knob assembly with both exploded views and a side cut.

FIG. 8 is a view of the circuit board.

FIG. 8a is a view of the circuit board with battery.

FIG. 9a and FIG. 9b illustrate the External Charge Ring sliding over the outer sleeve of the induction charging personal massager assembly.

FIG. 10a and FIG. 10b are side cut views of the External Charge Ring and the induction charging personal massager assembly connected.

FIG. 11a and FIG. 11b are assembled and exploded views of Vibration System assembly.

FIG. 12a and FIG. 12b are assembled and exploded views of the External Charge Ring assembly.

FIG. 13 shows the external charge ring assembly of FIG. 12.

FIG. 14 is a view of the magnet bumper from the magnet shaft.

FIG. 15 is a view of the magnet bumper and ball joint from the magnet shaft.

FIG. 16a and FIG. 16b are illustrations of the knob.

FIG. 17 is an illustration of the Magnet.

FIG. 18 is an illustration of half 1 of the main body—Magnet shaft and circuit board housing.

FIG. 19 is an illustration of half 2 of the main body—Magnet shaft and circuit board housing.

FIG. 20 is an illustration of half of the Vibration System enclosure.

FIG. 21 is an illustration of the opposite half of the vibration system closure of FIG. 20.

FIG. 22 is an illustration of the O-Ring.

FIG. 23 is an illustration of the Internal Coil.

FIG. 24 is an illustration of the External Coil.

FIG. 25 is an illustration of half 1 of the External Coil enclosure.

FIG. 26 is an illustration of half 2 of the External Coil enclosure.

FIG. 27a and FIG. 27b are illustrations of the outer sleeve of the inductive charging personal massager.

FIG. 28 is a block wiring diagram of the internal closed circuit system.

FIG. 29 is a block wiring diagram of the internal closed circuit system used with the External Charging Coil.

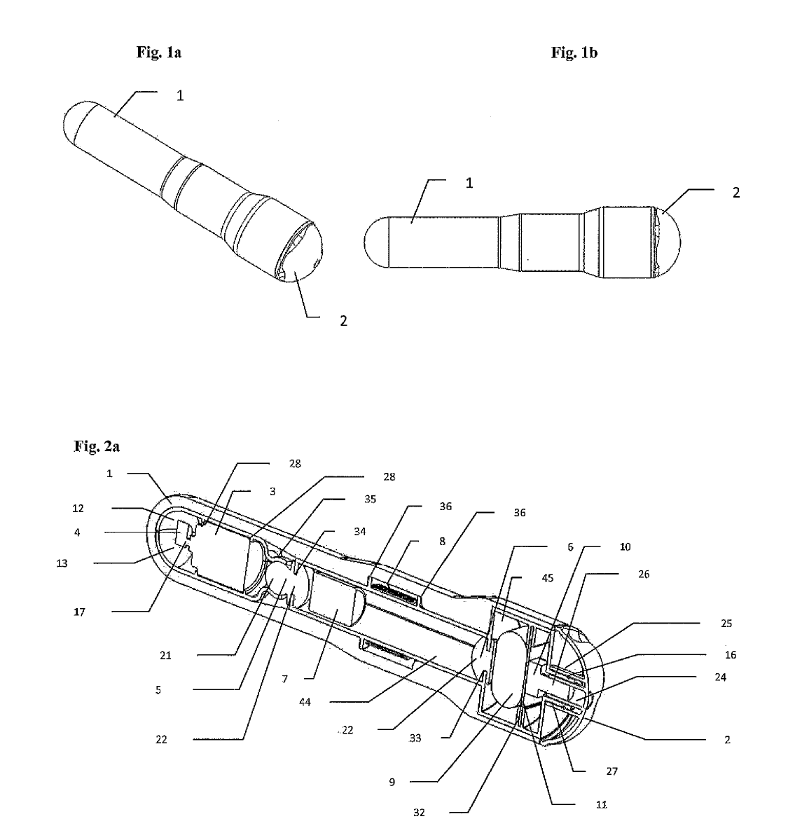

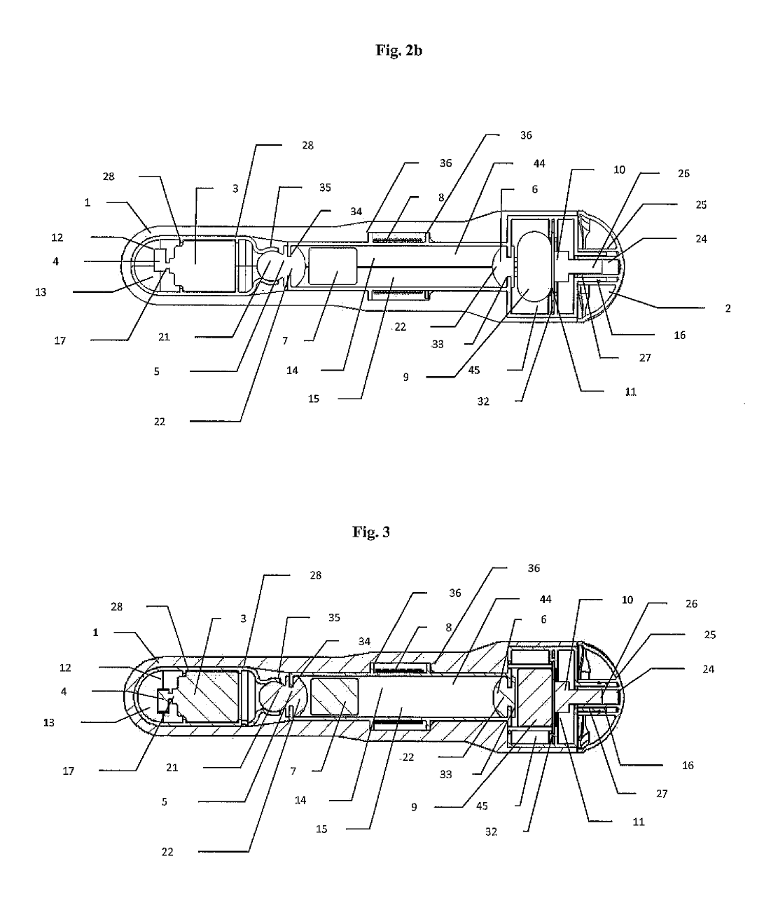

### BRIEF DESCRIPTION OF THE ILLUSTRATED EMBODIMENTS

1 Outer sleeve.
2 Knob.
3 Electric rotary motor.
4 Offset drive shaft weight.
5 Bumper and ball joint.
6 Bumper.
7 Induction Magnet.
8 Inner Induction Coil.
9 Energy Storage System
10 Potentiometer, motor speed controller.
11 Circuit board.
12 Vibration system enclosure half 1
13 Vibration system enclosure half 2.
14 Main body half 1—Magnet shaft and circuit board enclosure.
15 Main body half 2.—Magnet shaft and circuit board enclosure.
16 O-Ring.
17 Motor drive shaft.
18 Magnet sliding in direction 1.
19 Magnet sliding in direction 2.
20 Cut away through Vibration system enclosure for wire leads to motor from circuit board.
21 Spherical ball joint to attach Vibration System enclosure.
22 System for repelling Induction Magnet.
23 Groove for O-Ring in main body—Magnet Shaft and Circuit Board Enclosure.
24 Inner shaft on knob for contact with the potentiometer shaft.
25 Outer shaft on knob for contact with the O-Ring.
26 Shaft to Potentiometer, or Motor Speed Controller.
27 O-Ring Shaft on main body—Magnet Shaft and Circuit board Enclosure.
28 Grooves for holding Vibration Motor in place.
29 External Coil Ring Enclosure half 1.
30 External Coil Ring Enclosure half 2.
31 External Charging Coil.
32 Mounting Groove for the Circuit Board.
33 Through hole mount for bumper.
34 Through hole mount for bumper & ball joint.
35 Socket joint piece mounts to ball joint.
36 Mounting guides for Internal Coil.
37 Through hole for Internal Coil Wires.
38 Through hole for Vibration System power wires.
39 Wire leads to coil.
40 Wire leads to Vibration System.
41 Power Cord from External Charge Ring.
42 home wall outlet.
43 AC power supply.
44 Magnet Shaft.
45 Battery and circuit board compartment.
46 Motion of External Charge Ring sliding over inductive charging personal massager assembly.
47 Over charge protection system.
48 Current Control system/Current Rectifier.
49 Vibration system.
50 Energy Storage System.

### DETAILED DESCRIPTION OF THE INVENTION

With the interest of both the consumer and the environment interest in mind, the induction charging personal massager was developed to feasibly combine an electromagnetic induction charging system and the concept of the vibrating personal massager. This invention relates to hand held massager containing at least one vibrating component. Combining the use of electromagnetic induction charging system and various vibration motors for use as a personal massager, disposable batteries and direct plug-in AC power systems are done away with.

The inductive charging personal massager, in general, is a vibrating massager that is able to recharge its internal energy storage system both during operation and when in standby mode. The inductive charging personal massager preferably uses at least one of each of the following systems to effectively perform its designed task; a vibration system, internal energy storage system, internal electromagnetic charging system preferably including a coil and magnet, a charge protection system, a current control system, and an external coil attachment for use with the internal electromagnetic induction charging system.

One method of how the inductive charging personal massager is able to recharge its internal energy storage system is by converting mechanical energy to electrical energy. When personal massager is oscillated in linear, and/or circular motion—a magnet slides back and forth through the magnet shaft and is passed through the center of a coil of conductive material mounted preferably in a central location around the magnet shaft. At each end of the magnet shaft may be a bumper and/or repelling member that aids in repelling the induction magnet back through the internal coil to the other end of the magnet shaft—improving efficiency of the system, while decreasing noise of operation. The act of passing a material with magnetic properties through the center of a coil of conductive material produces an electrical current. This generated electrical current is used to charge the internal energy storage system. We will call this process of generating current by passing a magnet through a coil of conductive material—electromagnetic induction, also known as Faraday Induction.

The inductive charging personal massager also features a repelling system at each end of the magnet shaft to repel the induction magnet used in the electromagnetic induction charging system back and forth thorough the internal coil. The repelling/repulsion system used at each end of the magnet shaft may be comprised of, but is not limited to; a spring of metal or elastomeric material, elastomeric bumper, and/or a magnet with magnetic properties. This system of repelling the induction magnet back and forth though the internal coil may use a magnet, referred to as a Bumper Magnet, at each end of the magnet shaft. Each bumper magnet will face the main induction magnet with its same polar face, causing the induction charging magnet and bumper magnet to repel each other. This system of repelling the magnet back and forth through the use of a mechanical spring or bumper magnet will increase efficiency of the Electromagnetic Induction Charging system, and decrease noise of operation.

The electrical current that is generated by electromagnetic induction, also known as Faraday induction, is used to charge the internal energy storage system. The inductive charging personal massager uses the internal energy storage system to store energy and power the electronic components of the device such as the vibration system. Means of storing energy that the internal energy storage system uses may include, but is not limited to at least one of the following; a battery of any functional chemistry composition, a power capacitor, compressed air, a hydrogen separation and fuel cell system, mechanical energy storage, and/or any combination of the above mentioned methods.

The direction of the current generated from the electromagnetic induction process to the internal energy storage system must be controlled so that the positive end of the battery is always receiving the positive charge from the internal coil, and the negative end of the battery is always receiving the negative charge from the internal coil. This current control system that controls direction of current flow must also stop the current flowing from the internal energy storage system to the internal coil. One method of controlling the direction of current from the internal coil to the internal energy storage system is through the use of a series of diodes placed in-between the internal coil and internal energy storage system. The series of diode's that are connected between the internal coil and internal energy storage system are designed to control the direction of the current entering the energy storage system, rectifying it from Alternating Current, AC, to Direct Current, DC. When the magnet oscillates through the center of the internal coil from one side to another, the direction of the current induced by the electromagnetic induction system will oscillate respectively. The magnet oscillating through the internal coil generates an Alternating Current, the series of Diode's rectifies this Alternating Current into Direct Current—which is the type of current the internal energy storage system and vibration system preferably operates on.

An external air coil may be used to charge the internal energy storage system of the inductive charging personal massager. The powered external air coil plugs into a standard home wall outlet of 115 volts AC, or 220 volts AC in European homes to receive its power, and is completely enclosed and watertight. The external air coil fits over outer casing of the inductive charging personal massager and mounts concentrically around the internal coil. This relationship of the powered external coil mounted concentrically around the internal coil can induce a current wirelessly through electromagnetic induction in the internal coil. The external charging coil induces a varying electromagnetic field around the inner coil to induce an alternating current within the internal coil. The alternating current induced in the internal coil is rectified to direct current with the current control system, or diode rectifying system, used to rectify the current induced by the magnet oscillating back and forth through the inner coil as described above.

In addition to charging the internal energy storage system through electromagnetic induction processes, other methods of providing a charge to the internal energy storage system may be used. These methods of recharging the internal energy storage system may include, but are not limited to; solar photovoltaic, wind turbine, fuel cell, thermoelectric generator, crank and electric rotary generator, receiving energy via electromagnetic radiation—such as a microwave transmitter and receiver, pull cord connected to electrical rotary generator, and/or any combination of the above mentioned methods.

A system of protecting the internal energy storage system from charging beyond its means may be used to protect the system from damage and/or failure. There are many ways to monitor and control the charging of the internal energy storage system. These methods of safely charging and monitoring charge levels in the internal energy storage system may include, but are not limited to at least one of the following; digitally monitoring charge level and charge input, timer controlled, thermal cutoff to stop charge when the internal storage system temperature increases above a specific temperature usually indicating a full charge, slow charging at a small fraction of the total capacity of the internal energy storage system at a slower rate—also known as trickle charging, and/or fast charging at a higher percentage of total charge capacity of the internal energy storage system with active level monitoring. Any of the above systems may be used independently of each other, or in any combination with any number of the said charge controlling methods.

The digital charge monitoring method uses a programmable microchip to analyze collected data about the charge level of the internal energy storage system, and the charge entering the system to ensure the optimal charge level and battery life. Typically batteries show a steady increase in voltage as they are being charged, until the battery reaches its maximum charge capacity. When the battery reaches its maximum charge capacity, it will start to decrease in total charge, known as a negative Delta V. The digital monitoring system will cutoff charge current to the energy storage system when a negative Delta V is detected, or will switch to trickle charge mode and keep the battery topped off by allowing a small fraction of the total charge capacity to enter into the internal energy storage system.

A timer controlled charge monitoring system will time the incoming charge current from the start, and cut off the charge to the internal energy storage system after a specified period of time to protect the internal energy storage system from over charging.

The temperature monitoring charge control method uses a thermostat to monitor the temperature of the internal energy storage system. When the temperature of the internal energy storage system reaches a specified limit, the charge entering the battery will be cutoff. A higher raise in temperature in the internal energy storage system often indicates a fully charged system.

The Slow charging method of recharging the internal energy storage system administers a current or charge at a small fraction of the maximum capacity of the internal energy storage system. This small fraction is typically 10% or less, but may vary depending on the type of energy storage system—for example different battery chemistries. A Nickel Metal Hydride, or Ni-mh, battery can receive a charge at 0.1×(maximum capacity), or 10% of its maximum capacity at a steady rate indefinitely without overcharging. The 10% value is within temperature range of approximately 32° F. to 115+° F.

The rapid charging method will charge the internal energy storage system at a high percentage of its maximum charge capacity, 50% to 100%. The rapid charging method must be actively monitored by either the digital charge monitoring method, timed monitoring, and/or the temperature monitoring method to avoid over charging of the internal energy storage system.

The inductive charging personal massager preferably uses at least one vibration system for massage purposes. The method used for the vibration system to generate a vibrating motion may be, but is not limited to at least one of the following; an electric rotary motor with an offset weight fixed to the drive shaft, a solenoid, a coil, piezoelectric, an electromagnetic relay, and/or any combination of the above mentioned vibration generation systems. The vibration system is enclosed within a casing and mounted to the magnet shaft of the main body. The vibration system may be mounted with a spherical joint, or ball joint, to allow the vibration system to move with 3 degree's of freedom relative to the magnet shaft of the main body. The mounting joint that connects the motor and casing to the magnet shaft may be made out of a rubber or elastomeric material to dampen vibration transmitted to the magnet shaft. dampening vibration transmitted to the magnet shaft reduces the amount of transferred vibration to the magnet shaft and will reduce noise.

The speed of oscillation of the vibration system may be variable through user input. One method of controlling the intensity of vibration is to vary the resistance between the internal energy storage system, and the vibration system. A variable resistor or potentiometer can be used to vary the voltage flowing from the internal energy storage system to the vibration system. If the vibration system is a rotary DC electric motor with an offset weight fixed to its driveshaft, the potentiometer will vary the RPM's (rotations per minute) of the motors shaft, respectively varying the intensity of vibration.

The outer casing of the inductive charging personal massager that encloses the inner mechanisms may be made of, but not is limited to, the following materials; metal, plastic polymer, silicone, rubber, and/or any combination of these materials. The outer casing may also be fluid/water tight. Epoxy sealant and O-Rings (16 FIG. 1) may be used to properly seal off the inner mechanisms and systems form water and/or fluid damage.

The inductive charging personal massager may also feature a telescoping arm that connects the handle to the vibrating tip for extended reach and efficient/compact storage.

The inductive charging personal massager may also include interchangeable massaging tips. These massaging end caps will feature a variety of geometrical shapes to transmit the vibration in different ways.

FIG. 1 shows one embodiment of the present invention. There is an outer sleeve 1 that is provided with a vibrating end portion 2 which may be in the form of a knob. Within the sleeve is an electric rotary motor 3 that has an offset drive shaft weight 4 that causes the device to vibrate as the motor operates. Within the sleeve 1A there is a bumper 5 that cushions the movement of the induction magnet 7 as the magnet moves back and forth in the sleeve. On the opposite end of the sleeve there is a second bumper 6. Around the inner sleeve 1A induction coil 8 is wrapped. The induction coil 8 is connected to the energy storage system 9 for storing energy generated by the movement of the induction magnet through the sleeve 1A.

The bumpers 5 and 6 may be made of resilient material that causes the induction magnet 7 to bounce off the bumper for its return through the induction coil. Alternatively, the bumper may be replaced with a magnet having a polarity the same as the polarity of the end of the induction magnet closest to the magnet. The bumper may also be replaced with a spring. A helical spring can be used.

The electric current generated by the movement of the induction magnet 7 through the induction coil 8 is stored by the energy storage system 9. The energy storage system 9 may be, for example, a battery, a power capacitor, compressed air, a hydrogen separation and fuel cell system, a mechanical energy storage, i.e. storage of kinetic energy and combinations thereof.

The vibration system of the present invention may be mounted within the sleeve and held in place by a ring 3A and 3B in the housing at each end of the motor. The ring extends inwardly from the inner wall of the sleeve. In an embodiment where the outer sleeve of the housing is in two halves, there may be a vibration system enclosure half 12 and a vibration system enclosure half 13.

The system 22 for repelling the induction magnet can be, for example, a spring magnet or bumper. The bumper 5 may be made of a spring material that can cause the induction magnet to bounce off of the bumper. The bumper may be secured to the sleeve by a ball joint 21 and wall 21A extending into the waist portion of the resilient material used for the bumper with an opening formed by the wall in the housing to retain the bumper in position.

The speed of the motor and more particularly, the speed of the oscillation of the vibration system may be variable. A potentiometer 10 or other motor speed controller may be used to vary the voltage flowing from the internal energy storage system 9 to the vibration system 12, 13. The inner sleeve that the induction magnet travels through may be divided into a first main body half 14 and a second main body half 15. These halves enclose the magnet shaft and if desired, the circuit board enclosure for the circuit board 11.

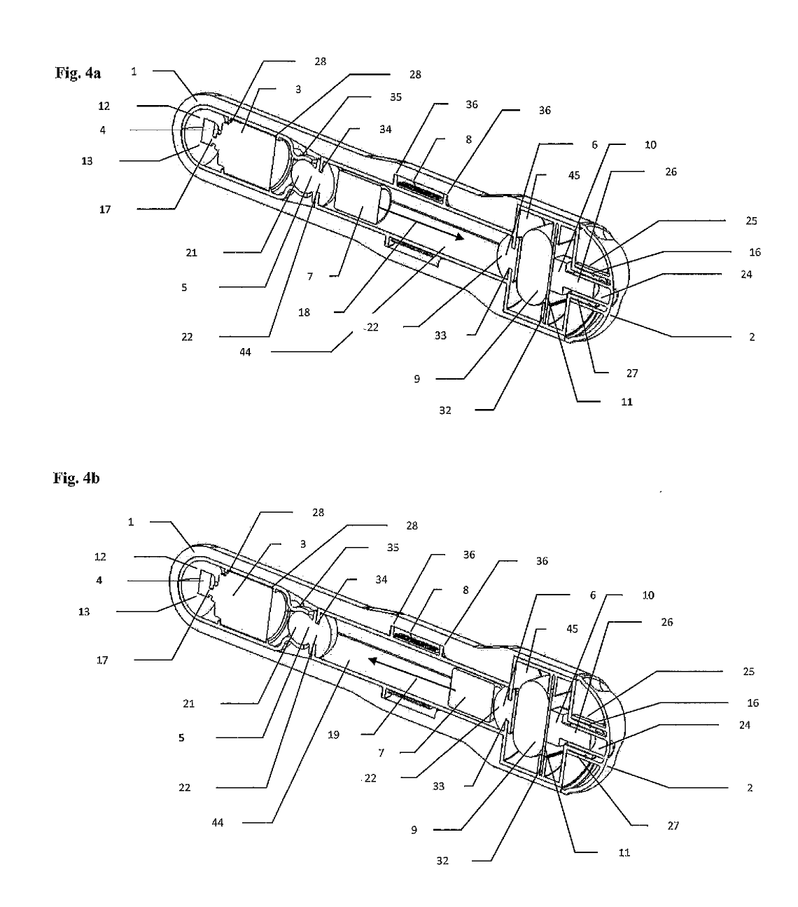

The offset drive shaft weight 4 rotates as motor drive shaft 17 is rotated by the motor 3. Electricity is generated by the sliding of the induction magnet 7 in the sleeve through the induction coil 8. As the magnet moves through the sleeve in a first direction 18, see FIG. 4a, it hits the bumper 6 where it bounces off and travels in the return direction 19 through the induction coil 8 to bumper 5 where the process is repeated as necessary to generate sufficient current to operate the vibration motor or to be stored in the energy storage system 9.

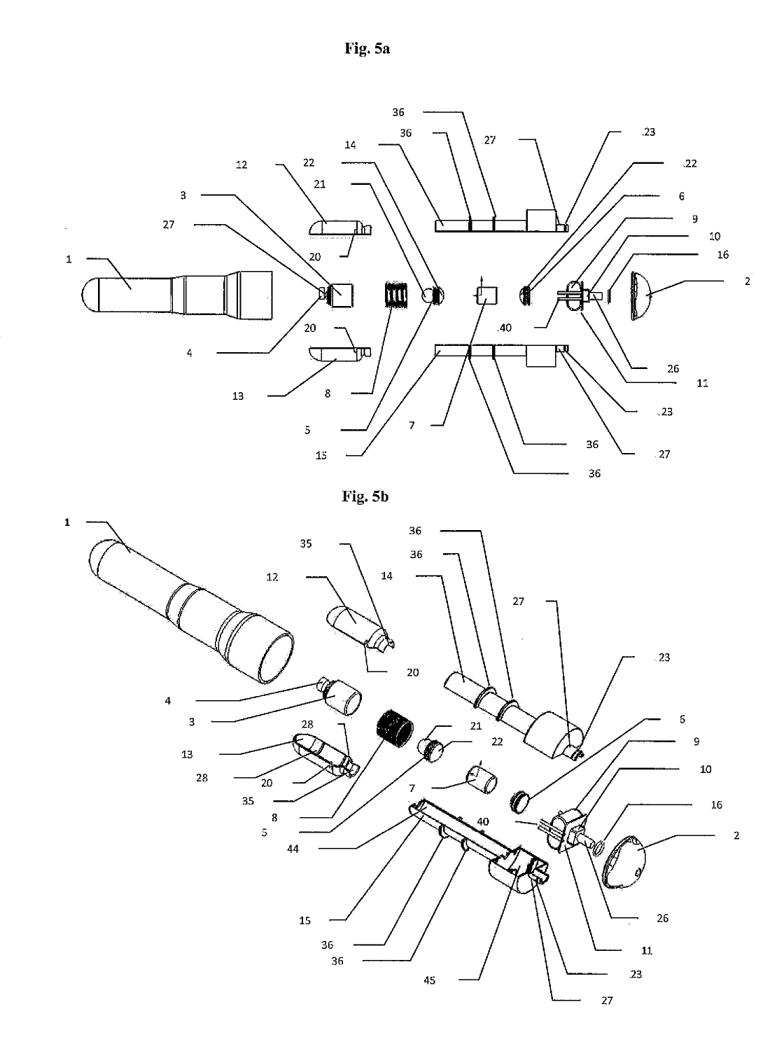

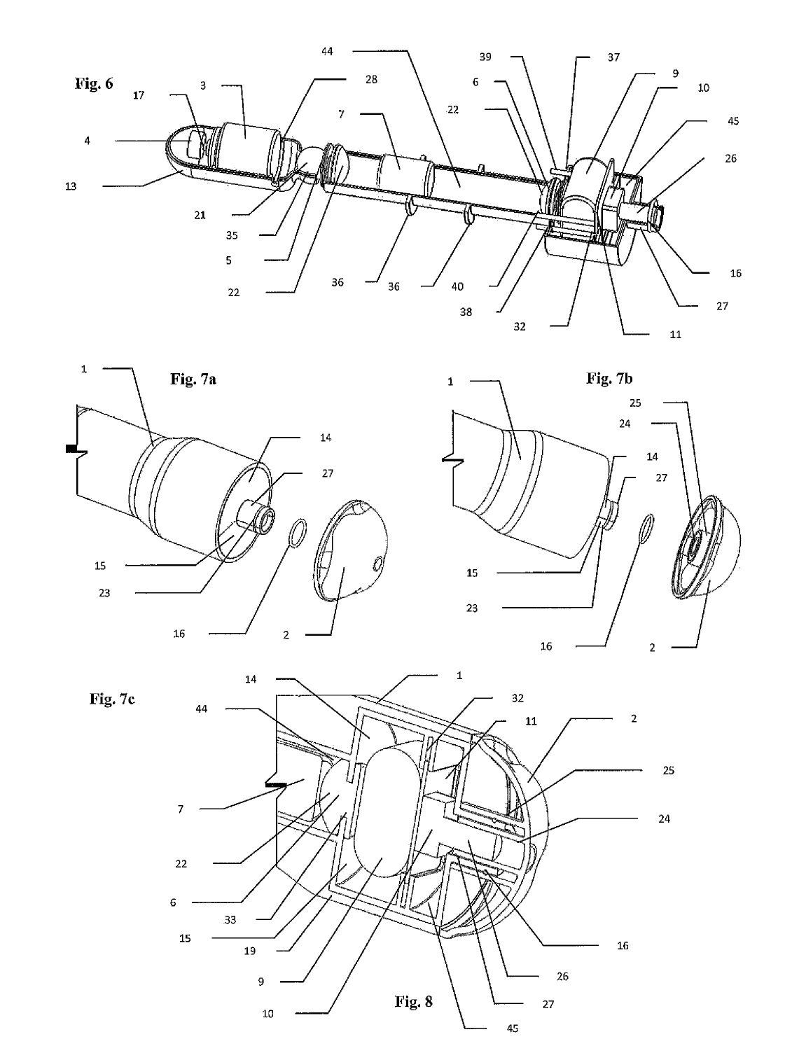

The exploded views of FIGS. 5a and 5b arrangement of the interior of the massager in more detail. FIG. 6 shows the massager with the top half of the massager being removed. FIGS. 7a to 7c show the O-ring and knob assembly. There are the main body halves 14 and 15 having an O-ring shaft 27. The shaft 27 has a groove 23 for receiving a O-ring 6. The knob 2 may be positioned over the end of the main body halves 14 and 15 and hold them in position. The knob has an inner shaft 24 for contact with the potentiometer or speed controller 10, shaft 26 and an outer shaft on the knob 2 for contact with the O-ring.

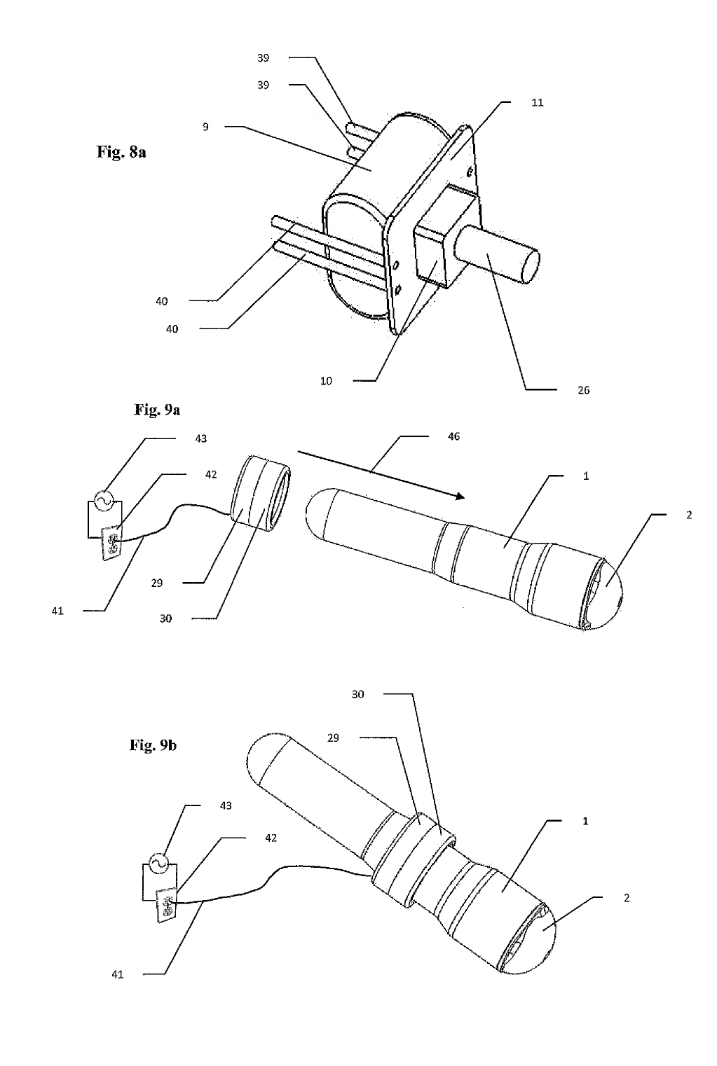

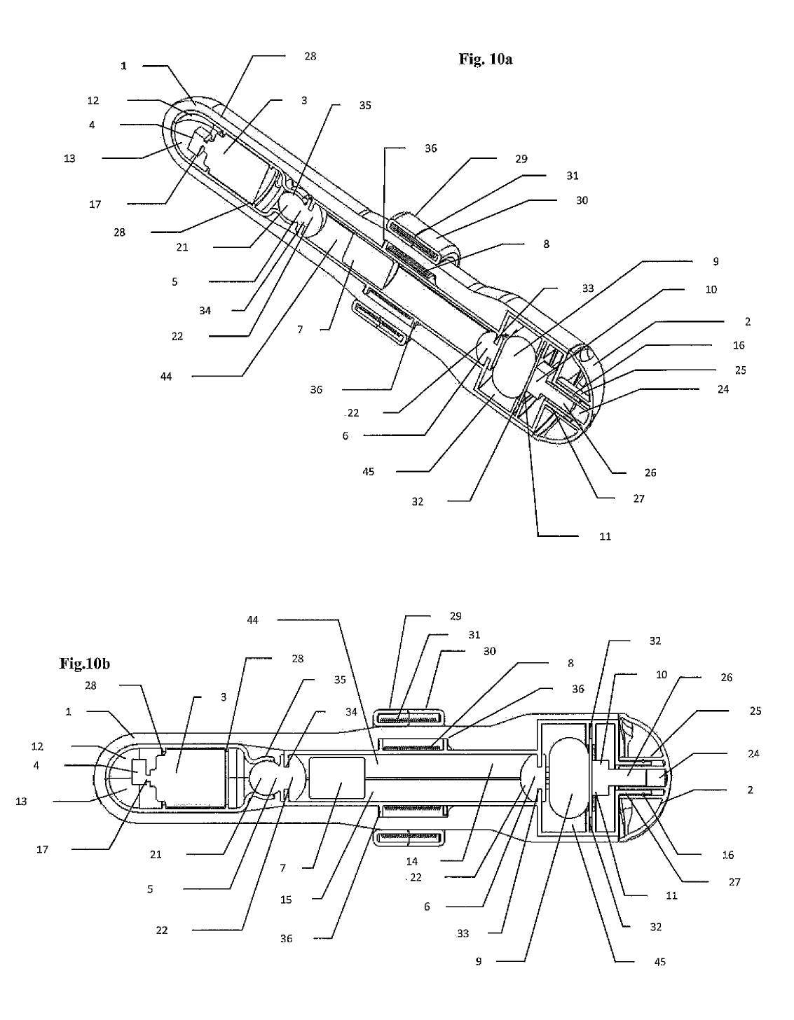

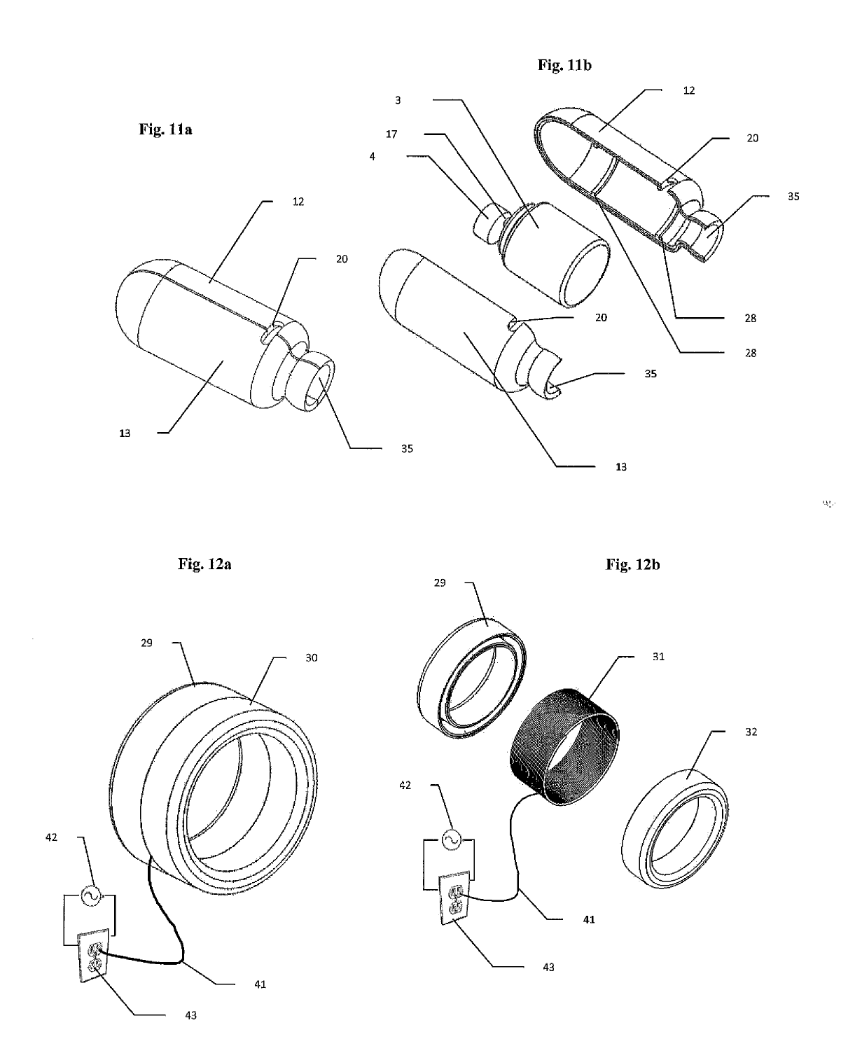

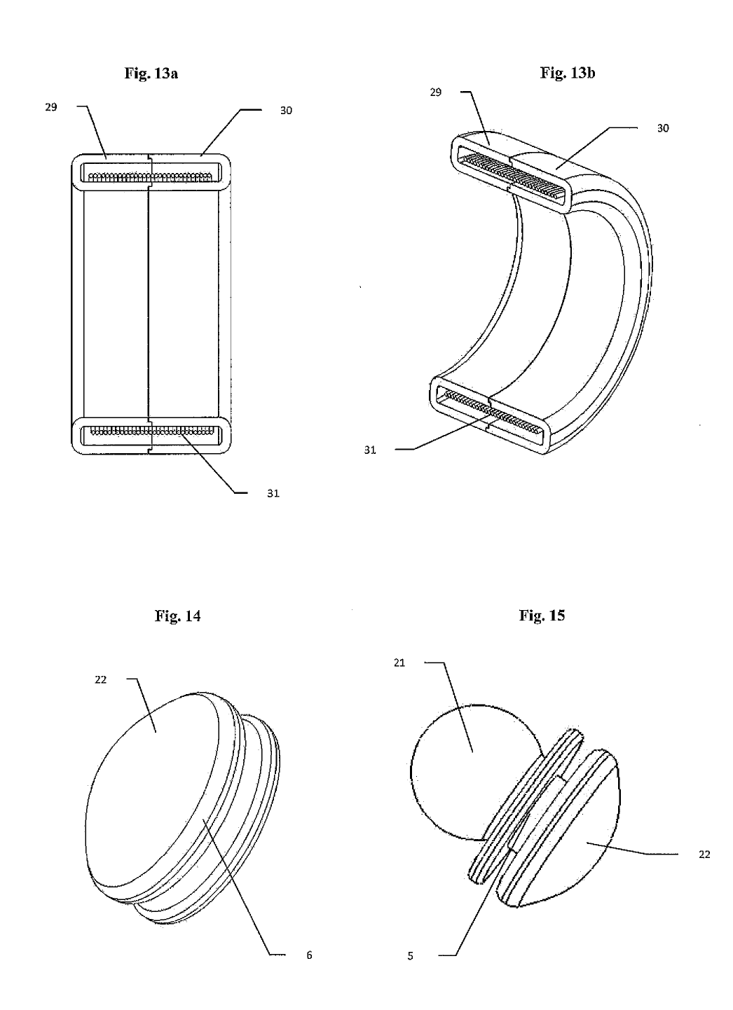

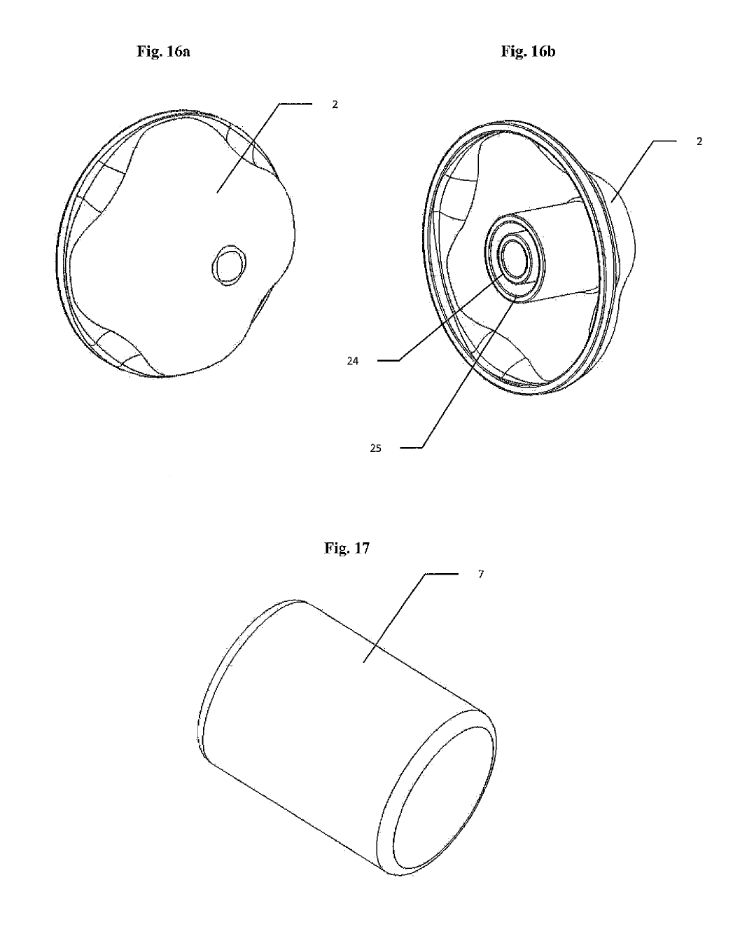

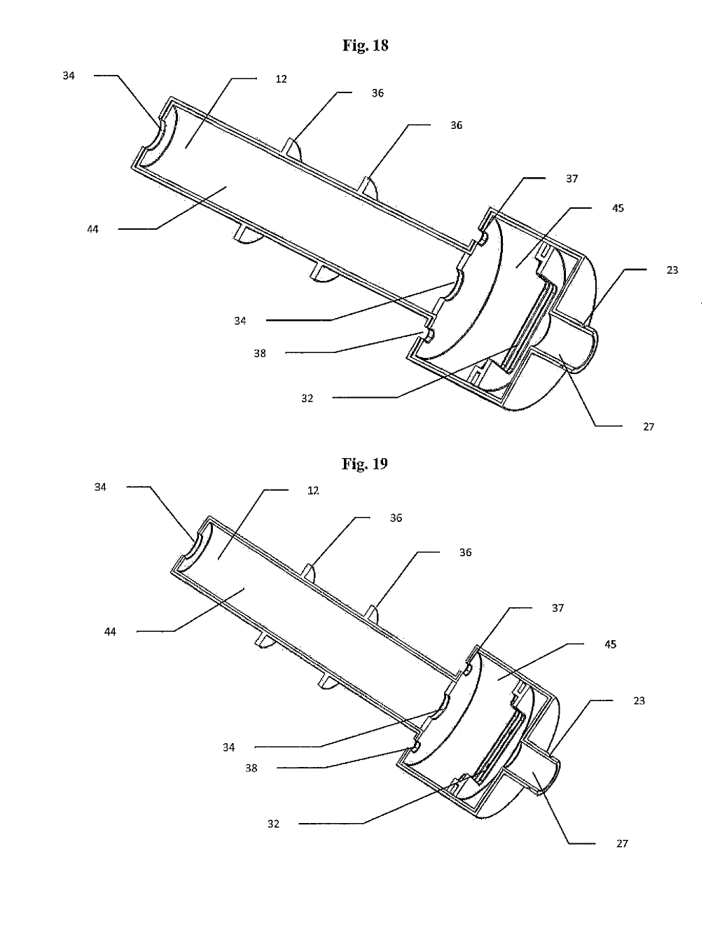

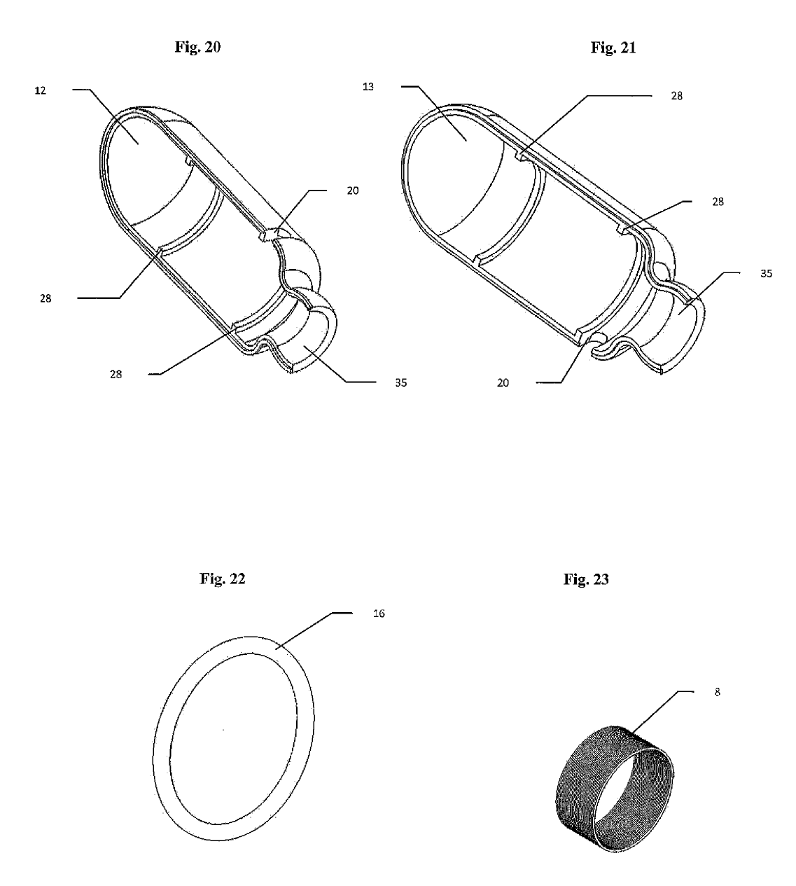

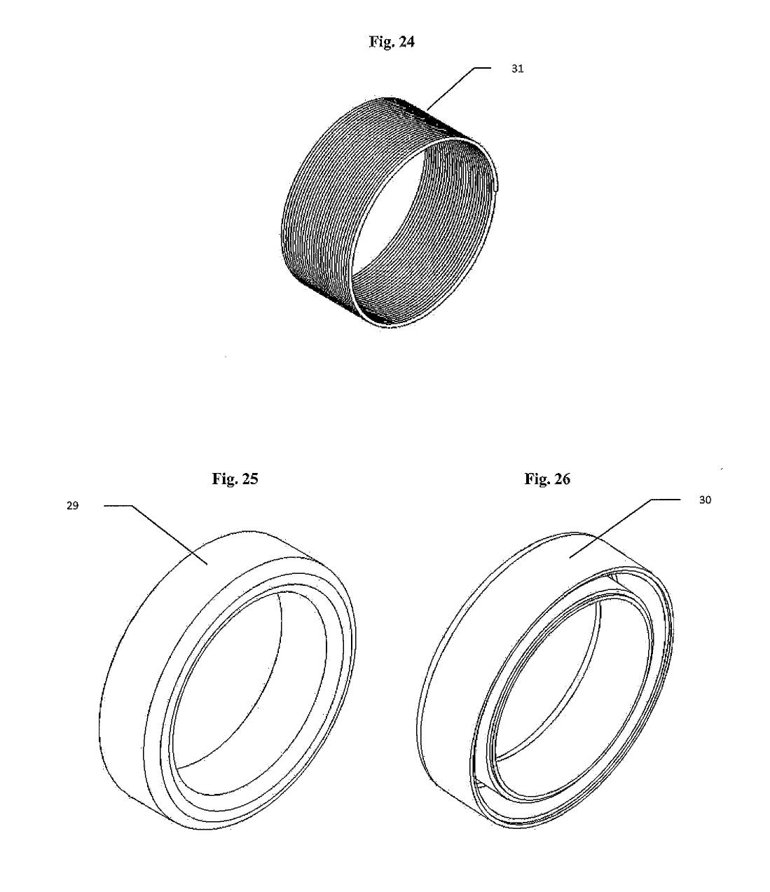

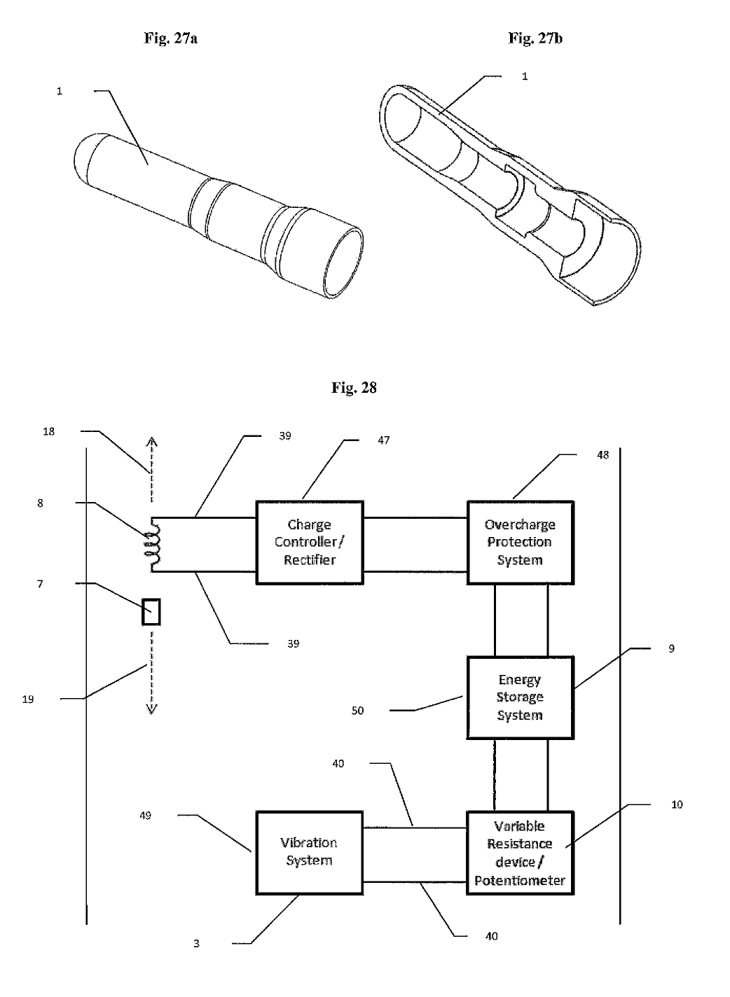

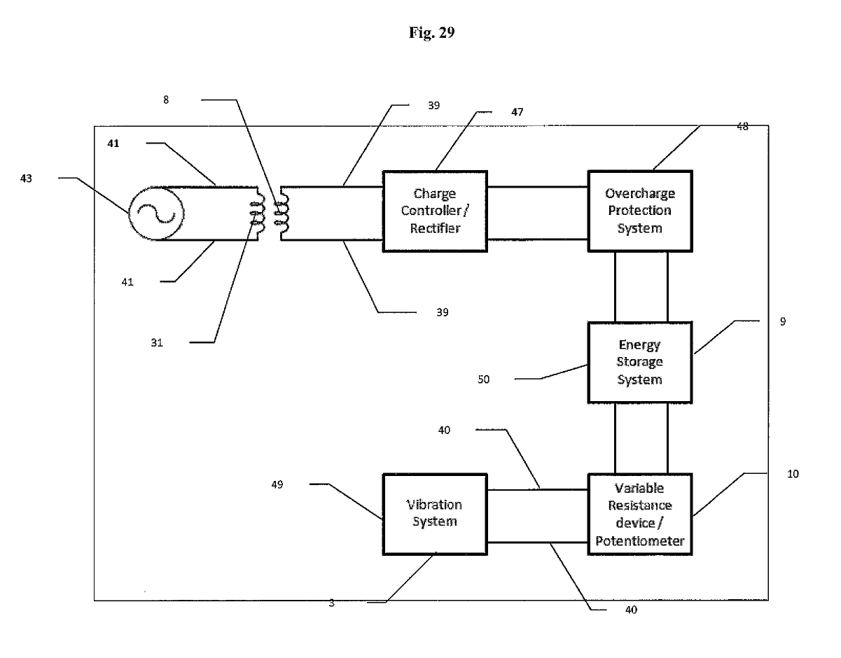

FIG. 8 shows the energy storage system 9 and circuit board compartment 45 that receives circuit board 11. FIG. 8a shows the circuit board and battery. FIG. 9 shows the external charge ring which is made up of the external coil ring enclosure 29 and 30. The ring goes over the outer portion of the housing as seen in FIG. 9b. The ring is electrically connected to a power cord 41 which may be plugged into outlet 42 of an AC power supply FIG. 10a and FIG. 10b show a cutaway view of the induction charging personal massager with the external charge ring in position. FIG. 12a shows the charge ring in more detail FIG. 12b is an exploded view of the charge ring FIGS. 13a and 13b show a cut away view of the charge ring. FIG. 11a shows the vibration system assembly. FIG. 11b is an exploded view of FIG. 11a. FIG. 14 shows the bumper 6 in more detail. FIG. 15 shows bumper 5 has spherical ball joint 21 to help secure it in position in the assembly. FIG. 16a and FIG. 16b show the front and rear of the knob 2. There is an inner shaft 24 on the knob for contact with the potentiometer shaft. There is also an outer shaft 25 on the knob that receives an O ring 16. FIGS. 18 and 19 show the magnet shaft and circuit board housing. FIGS. 20 and 22 show the vibration system enclosure.

I claim:

1. A personal massager comprising a housing having an inner sleeve, said inner sleeve having first end and a second end, said sleeve having an induction magnet that travels in said sleeve from one end portion of said inner sleeve to an opposite end portion, said induction magnet passing between an induction coil that is wrapped about said sleeve as said induction magnet travels through said sleeve by movement of said housing by a user, said movement of said induction magnet through said coil generating an electric current that drives said vibrating motor.

2. The personal massager according to claim 1 wherein said vibration means is an electric motor with an offset weight mounted to a driveshaft.

3. The personal massager according to claim 1 wherein said vibration means is an piezoelectric material.

4. The personal massager according to claim 1 wherein said vibration means is a solenoid.

5. The personal massager according to claim 1 wherein said vibration means is an electromagnetic relay.

6. The personal massager according to claim 1 wherein said vibration means is a coil.

7. The personal massager according to claim 2 further comprising a means for storing energy generated by said induction magnet.

8. The personal massager according to claim 7 wherein said means for storing energy is a rechargeable battery.

9. The personal massager according to claim 7 wherein said means for storing energy is a power capacitor.

10. The personal massager according to claim 7 wherein said means for storing energy is compressed air.

11. The personal massager according to claim 7 wherein said means for storing energy is a capacitor.

12. A personal massager comprising a housing having a vibration means in said housing, said housing having a power generation means for driving a vibration means.

13. The personal massager according to claim 12 wherein said power generation means is an electromagnetic charging system.

14. The personal massager according to claim 12 wherein said power generation means is a photovoltaic solar cell.

15. The personal massager according to claim 12 wherein said power generation means is a pneumatic generator.

16. The personal massager according to claim 12 wherein said power generation means is a thermoelectric generator.

17. The personal massager according to claim 8 further comprising a charge control device for rectifying alternating current to direct current.

18. The personal massager according to claim 17 wherein said charge control device stops current from flowing from the energy storing means to the induction coil.

19. The personal massager according to claim 17 wherein the charge level of the battery is monitored.

20. The personal massager according to claim 19 further comprising a thermal cut off to stop charging the battery when an internal storage temperature increases above a pre-determined temperature.

21. The personal massager according to claim 20 at least one of said end portions of said inner sleeve has a rebounding means.

22. The personal massager according to claim 21 wherein said rebounding means is a spring.

23. The personal massager according to claim 21 wherein said rebounding means is an elastomeric spring.

24. The personal massager according to claim 21 wherein said rebounding means is one or more magnets.

25. The personal massager according to claim 21 further comprising a means for controlling the intensity of vibration.

26. The personal massager according to claim 25 wherein the means for controlling the intensity of vibration comprises varying the resistance between the internal energy storage system and the vibration means.

27. The personal massager according to claim 26 wherein said means for varying resistance is a variable resistor.

28. The personal massager according to claim 26 wherein said means for varying resistance is a potentiometer.
